(19) United States
(12) Patent Application Publication
(10) Pub. No.: US 2015/0093539 A1
(43) Pub. Date: Apr. 2, 2015

(54) GLASS LAMINATE COMPRISING AT LEAST ONE SHAPED PART MADE OF METAL

(71) Applicant: Glas Trösch Holding AG, Buochs (CH)

(72) Inventors: Roland Krugmann, Augsburg (DE); Bruno Kassnel-Henneberg, Diedorf (DE)

(21) Appl. No.: 14/474,996

(22) Filed: Sep. 2, 2014

(30) Foreign Application Priority Data
Sep. 27, 2013 (CH) 1651/13

(51) Int. Cl. B32B 17/10; B32B 38/00; E06B 3/66; B32B 37/18; B32B 3/08; B32B 3/06

(52) U.S. Cl. CPC B32B 17/10293; B32B 3/08; B32B 3/06; B32B 17/10036; E06B 3/66; B32B 37/182; B32B 38/0004; B32B 2250/03; B32B 2250/05; B32B 2250/40
USPC 428/99; 428/192; 156/257

(57) ABSTRACT

The present application relates to a glass laminate (1) comprising at least two glass plates (2, 3). At least one first polymer film (4) and also at least one shaped part (5) made of metal are arranged between said at least two glass plates (2, 3). The at least one shaped part (5) has substantially the same thickness as the at least one first polymer film (4). The first polymer film (4) has a cutout (10), in which there is arranged the shaped part (5). The shaped part (5) furthermore has at least one first region (6) which engages with the at least one first polymer film (4) in a form-fitting manner in the form of an undercut.

### TECHNICAL FIELD

The invention relates to a glass laminate comprising at least one polymer film arranged between two glass plates and at least one shaped part made of metal and also to a process for producing such a glass laminate.

### PRIOR ART

Glass laminates comprising at least one polymer film arranged between two glass plates are known, for example from automotive construction or from the field of safety glasses. Furthermore, various methods for connecting such glasses to further elements, for example a facade, are known in the prior art.

By way of example, U.S. Pat. No. 7,165,362 (Apple Computer) describes a glass laminate as a load-bearing structure, e.g. for a step. A side edge of a glass pane of the laminate has cutouts, into which connection elements can be inserted and in which the latter can be adhesively bonded. The connection elements can be used to fasten the glass laminate structure to further elements. The connection elements can be shaped differently, but preferably have a curved shape.

DE 20 2006 007 201 U1 (Seele GmbH & Co. KG) describes a laminated glass pane consisting of at least two individual panes, the outermost pane having a depression which does not penetrate through the entire pane, and the inner pane comprising a corresponding through-hole through which a connection piece which engages into the depression in the outer pane can be pushed. The depression and the hole in the glass panes can also have an undercut or an otherwise conical contour.

DE 202 18 215 U1 (Platz Karl Otto) discloses a fastening means for laminated glass panes, said fastening means comprising a clamping element which exerts a clamping force only on a support glass pane of the laminated glass pane. The clamping element is for this purpose guided through a cutout in the support glass pane, a flange part of the clamping element engaging behind the support glass pane.

SE 519551 C (Fasadglas Backlin AB) describes a glass laminate comprising three glass panes, in which an anchoring element is inserted in a cutout on a side edge of the middle glass pane. The anchoring element is in this case connected to the two outer glass panes in the cutout via the intermediate polymer layers.

EP 1 297 237 (Saint-Gobain Glass France) discloses a fastening apparatus for a multi-layered wall element, for example for a laminated glass. A pane on the building side has a through-hole, while a pane on the outside has a recess arranged coaxially with respect to the through-hole. A fastening element is introduced through the through-hole, an end portion of said fastening element penetrating into the recess in the pane on the outside. The hollow space between the fastening element and the panes is filled by a cured filling compound. The recess can in this case have a greater diameter than the through-hole, as a result of which an undercut suitable for fastening the fastening element is formed.

These methods for fastening connection elements all have the disadvantage that either openings or cutouts have to be worked into one or more of the glass panes of the glass laminate. Particularly for the production of glass laminates having variable sizes and with different positioning of the connection elements, this represents a not inconsiderable additional outlay which slows down the production of such glass laminates and makes the production more expensive as a whole.

Moreover, when fastening the connection elements via an intermediate polymer layer or a separately applied adhesive, the bond of these connection elements can be ascertained only with difficulty on a permanent basis and can be impaired by external weathering influences, such as solar radiation, moisture or a change in temperature. Therefore, after a relatively long time the bond between connection element and glass laminate can weaken, and this impairs the operational safety of such a glass laminate. For structural applications in which it is planned for loads to be removed, this can mean that such an application is not possible. In addition, cutouts or openings which have been made in the glass panes weaken the glass component as a consequence of increased stresses in the region of the cutouts or openings.

### SUMMARY OF THE INVENTION

It is an object of the invention to provide a glass laminate which is appropriate to the technical field mentioned in the introduction and in the case of which it is possible to introduce a shaped part made of metal, in particular a connection element, in an efficient and inexpensive manner, with a secure and reliable connection being achieved between the shaped part and the laminate.

The object is achieved by the features of claim 1. The glass laminate according to the invention comprises at least two glass plates, at least one first polymer film and also at least one shaped part made of metal being arranged between said at least two glass plates. The at least one shaped part has substantially the same thickness as the at least one first polymer film. The polymer film has a cutout, in which there is arranged the shaped part. The at least one shaped part furthermore has at least one first region which engages with the at least one first polymer film in a form-fitting manner in the form of an undercut. Furthermore, the at least one shaped part is arranged in the region of an edge of the glass laminate and has a width which is less than 10% of the length of the edge. The width of the at least one shaped part is preferably less than 5% of the length of the edge.

By virtue of the form-fitting engagement of the shaped part in the at least one first polymer film, the shaped part is additionally anchored in the plane of the glass plates so that it cannot be pulled out. In order to hold the shaped part in the glass laminate, no additional adhesive bonding of the shaped part is therefore necessary in the present invention. Since the at least one shaped part has a width which is smaller by a number of orders of magnitude than the length of the edge of the glass laminate in the region of which the at least one shaped part is arranged, it is possible to achieve a substantially only punctiform arrangement of the at least one shaped part. The compact shape of the shaped part introduced into the laminate reduces the stresses which arise in principle in the glass laminate as a consequence of the different coefficients of thermal expansion between metal and film, this improving the durability of the glass laminate in the region of the shaped part introduced into the laminate.

It is further preferable that the at least one shaped part has a width which is less than 5% of the length of the edge of the glass laminate, in particular less than 2.5% or less than 1%. Particularly when a plurality of shaped parts are arranged in the region of the same edge of the glass laminate, the widths thereof when added together must not exceed 25% of the length of the edge. It is particularly preferable that the widths when added together should not exceed 10% of the length of the edge.

Hereinbelow, “laminate” is used as a synonym for “glass laminate”.

The at least two glass plates can be any desired glass plates which are used for a safety or laminated glass. The glass plates can in this respect have any desired dimensions and also any desired shape which is suitable for the respective intended use of the glass laminate. The thickness of the glass plates used can also vary depending on the intended use of the glass laminate.

The first polymer film is used as an intermediate layer of the laminate. The first polymer film can consist of any suitable polymer material which exhibits sufficiently strong adhesion to the glass plates and moreover a sufficiently high tensile strength so that secure anchoring of the shaped part in the laminate is ensured. An intermediate layer film of this type is sold, for example, by DuPont under the name SentryGlas® Ionoplast.

It is particularly preferable for the polymer film to be transparent, so that an undistorted view through the glass laminate is made possible. As an alternative, however, the polymer film can also have a coloration or be printed with an image, lettering or the like. Furthermore, the polymer film can also have a different permeability to radiation outside the visible range, in particular a relatively small permeability to UV rays.

The shaped part can consist of any desired metal suitable for the specific function of the shaped part, for example of steel, aluminum or titanium. The thickness of the shaped part in this case preferably corresponds to the thickness of the polymer film used. This thickness is, for example, from 0.8 mm to 3.0 mm. Within the context of this application, “substantially” means a deviation of ±10%.

The cutout in the first polymer film is preferably shaped and dimensioned in such a manner that the shaped part fits flush into the cutout. This prevents the shaped part from having a motion clearance within the glass laminate, which would have a negative effect particularly when the shaped part is used as anchoring of the glass laminate.

The shaped part can have any desired shape and dimension suitable for its respective function. A single restriction in relation to the dimension of the shaped part lies in the thickness of the shaped part, which—as already stated further above—corresponds substantially to the thickness of the first polymer film used. In addition, in the first region the shaped part has to have a shape which engages with the cutout in the first polymer film in a form-fitting manner in the sense of an undercut. In particular, the shaped part can have at least one widened section and/or at least one incision, which widen and/or diminish the at least one shaped part in a plane parallel to the plane of the at least two glass plates. The at least one incision and/or the at least one widened section can have any desired shape, in particular a polygonal or rounded shape. It is further preferable that the at least one shaped part can also have an opening with any desired shape arranged within the surface area of the shaped part. In the case of such a configuration, a correspondingly cut out element of the at least one first polymer film is placed into said opening in the shaped part, in order to make it possible to achieve an adhesive bond between the at least two glass plates within said opening. It is particularly preferable that an inner opening is combined with a relatively wide region with an undercut, in order to increase the anchoring of the shaped part within the glass laminate.

Depending on the intended use of the glass laminate, provision can also be made of further laminate layers respectively with an intermediate polymer layer arranged between two glass plates. In this case, at least one shaped part can be arranged in each intermediate layer or alternatively only in one of a plurality of intermediate layers of a multi-layered glass laminate.

It is further preferable that provision can also be made for a plurality of shaped parts to be arranged between two glass plates. In this case, said plurality of shaped parts can have the same shape and size or alternatively also different shapes and sizes, depending on the intended use of the individual shaped parts.

Furthermore, it is also possible to arrange a plurality of layers of the first polymer film one above another between the at least two glass plates. In this case, each of said first polymer films can have a corresponding cutout for the at least one shaped part. In this case, the shaped part can have the same thickness as the plurality of first polymer films placed one on top of another.

It is preferable that the at least one shaped part has a second region, which protrudes beyond the edge of the glass laminate. As a result, the shaped part can be used for anchoring the glass laminate to a further structure, for example facade scaffolding, a door hinge or window hinge or the like. Alternatively, however, the shaped part can also be provided as an electrical conductor, in order to conduct for example current or data signals into or through the glass laminate.

It is particularly preferable that a plurality of, in particular two, shaped parts are arranged in the region of one edge, but preferably of two opposite edges, of the glass laminate, said shaped parts having a second region which protrudes beyond the edge. As a result, the glass laminate can be connected to a further structure in a simple and secure manner via the shaped part.

It is preferable that the shaped part has at least one connection element in the at least one second region. At least one layer of the at least one first polymer film is arranged between the connection element and the edge of the glass laminate.

As a result, a connection element can be laminated onto the edge of the glass laminate on the end face in a particularly stable and efficient manner. By virtue of the connection element, the at least one shaped part can be used particularly advantageously for anchoring the glass laminate to a further structure. In particular, the connection element can have at least one connection structure, for example a hole, a threaded hole, a latching element or the like, with the aid of which the connection element can be connected to a further structure in a particularly simple and efficient manner.

It is further preferable that the connection element has a shape in the case of which at least one side face of the connection element stands flush with respect to the surface of at least one glass plate of the glass laminate. As a result, it is possible to provide an esthetically particularly pleasing unit of glass surface and connection element.

It is particularly preferable that the connection element is configured as a cuboid, of which a respective face stands flush with respect to a respective one of the at least two glass plates of the glass laminate.

It is preferable that the at least one layer has at least one recess, in which there is arranged an element made of a thermoplastic polymer, in particular made of polymethyl methacrylate, having the same thickness as the at least one layer.

As a result, the distance between the connection element and the edge of the glass laminate can be observed exactly, even if the at least one layer—as well as the at least one first polymer film within the glass laminate—becomes very soft during the lamination through heating considerably above the glass transition temperature of the polymer used. This makes it possible to maintain the position of the connection element during the lamination process. This makes it possible to arrange shaped parts with connection elements precisely on the edges of a glass laminate in a manner specific to the application, without this precise positioning being lost in the further production process for the glass laminate.

It is preferable that the at least one first polymer film comprises a polymer with a modulus of elasticity of at least 100 N/mm² at a temperature of 50° C. and with a loading duration of approximately 3 seconds or less.

As a result, it is possible to produce a particularly stable glass laminate which withstands brief loading peaks even at an elevated temperature, e.g. as a consequence of solar radiation.

It is preferable that the at least one first polymer film comprises a polymer with a modulus of elasticity of at least 15 N/mm² at 50° C. and with a loading time of 1 hour.

The requirements for stable glazing even at an elevated temperature can be satisfied with a film of this type.

It is preferable that at least one second polymer film is arranged between the at least one first polymer film and at least one, preferably both, of the at least two glass plates, said second polymer films lying in the region of the cutout in the at least one first polymer film between the at least one shaped part and the at least two glass plates.

The arrangement of at least one second polymer film between the first polymer film and the first glass plate and/or the second glass plate additionally makes it possible to produce an adhesive bond between the shaped part and the at least two glass plates, this additionally improving the fastening of the shaped part within the glass laminate.

Depending on the application, it is also possible for more than just one second polymer film to be arranged on both sides between the first polymer film and the at least two glass plates, depending on which properties are desired for the glass laminate.

The at least one first polymer film should additionally exhibit a sufficiently strong verified adhesion to the at least two glass plates.

It is preferable that the polymer film comprises a copolymer consisting of ethene and methacrylic acid. It is particularly preferable that such a polymer film additionally comprises metal ions. A polymer film of this type exhibits good adhesion properties on glass, a high tensile strength and also a modulus of elasticity in a suitable range. It is thereby possible to provide a glass laminate which is rigid and stable at the same time and also allows for a desired high pull-out force for a shaped part made of metal introduced therein.

The present invention furthermore relates to a process for producing a glass laminate comprising at least two glass plates, a first polymer film and also at least one shaped part made of metal being arranged between said at least two glass plates. Firstly, a first glass plate, the at least one shaped part made of metal and the first polymer film are provided. The at least one shaped part comprises at least one first region which has a shape with an undercut. Then, a cutout is produced in the first polymer film, the cutout corresponding to the shape and size of the at least one shaped part. The first polymer film is applied to the first glass plate and the at least one shaped part is inserted into the cutout. The shape of the at least one first region of the shaped part with the undercut is in such a form that said at least one first region of the shaped part engages with the first polymer film in a form-fitting manner via the undercut. Then, a second glass plate is applied and the two glass plates are combined with one another to form a glass laminate by heating the first polymer film.

Depending on the application, further laminate layers each consisting of at least one polymer film arranged between two glass plates can also be added before the glass plates are combined.

The combination of the at least two glass plates, that is the lamination step, can also be subdivided into partial steps. By way of example, firstly a primary laminate can be produced by heating the polymer film, said primary laminate then being processed to form the finished glass laminate with the application of pressure and heat.

It is preferable that at least one second polymer film is applied to the first glass plate before the application of the first polymer film and then the first polymer film is applied to said at least one second polymer film.

As a result, an additional polymer film layer can be added to the glass laminate. Since the at least one second polymer film does not have a cutout for the at least one shaped part, the at least one shaped part is subsequently applied to said at least one second film, whereby the at least one shaped part additionally adheres to the first glass plate in the finished glass laminate.

It is preferable that at least one second polymer film is applied to the first polymer film and the shaped part before the second glass plate is applied. As a result, it is possible in turn for at least one additional polymer film layer to be added to the glass laminate. It is particularly preferable that at least one second polymer film is applied both between the first glass plate and the first polymer film and also between the latter and the second glass plate. As a result, the at least one shaped part can additionally be connected to the two glass plates in a force-fitting manner on both sides.

Further advantageous embodiments and combinations of features of the invention become apparent from the following detailed description and from the entirety of the patent claims.

### BRIEF DESCRIPTION OF THE DRAWINGS

The drawings used to explain the exemplary embodiment show:

FIG. 1 a perspective view of a glass laminate according to the invention;

FIG. 2 a plan view of a glass laminate having shaped parts of differing shape;

FIG. 3 a section through the glass laminate shown in FIG. 1;

FIGS. 4a, 4b two plan views of an excerpt of a glass laminate having a shaped part with two alternative embodiments of a connection element;

FIG. 5 a section through the glass laminate shown in FIG. 4a;

FIG. 6 a section through a glass laminate as shown in FIG. 4a with an alternative embodiment of a connection element.

In principle, identical parts are provided with identical reference signs in the figures.

### WAYS OF CARRYING OUT THE INVENTION

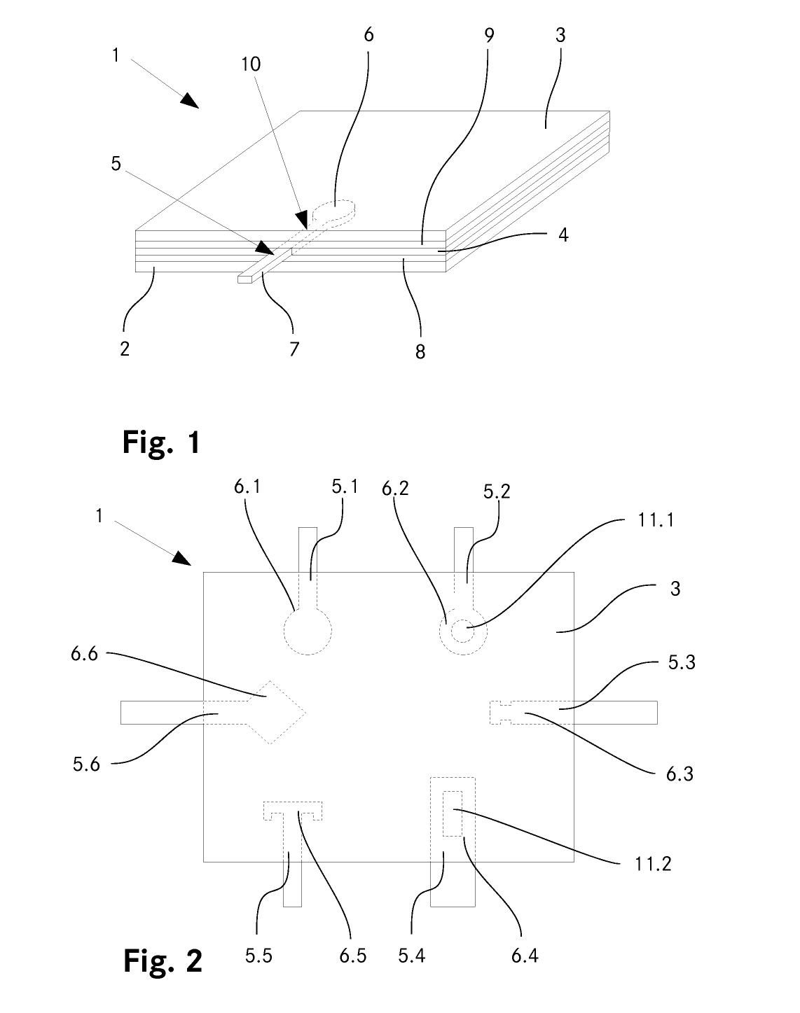

FIG. 1 shows a glass laminate 1 according to the invention in a perspective view. The glass laminate comprises a first glass plate 2 and also a second glass plate 3. A first polymer film 4 and also two layers of the second polymer film 8, 9 are arranged between the two glass plates 2, 3. In this case, the first polymer film 4 is inserted between the two layers of the second polymer film 8, 9. A second region 7 of a shaped part 5 made of metal protrudes beyond an edge of the glass laminate, whereas a first region 6 of the shaped part 5 is inserted in a cutout 10 in the first film 4. The first region 6 of the shaped part 4 has a shape which engages with the first polymer film 4 in a form-fitting manner in the sense of an undercut. Furthermore, the shaped part 5 is additionally connected to the two glass plates 2, 3 in a force-fitting manner by the layers of the second polymer films 8, 9 which are present between it and the two glass plates 2, 3. Owing to the shape of the second region 6 of the shaped part 5, the latter is held in the glass laminate 1 such that it cannot slip or be pulled out. The thickness of the shaped part 5 corresponds substantially to the thickness of the first polymer film 4. Furthermore, the cutout 10 has a shape and size which correspond to the shape and size of the shaped part 5. This makes it possible to achieve a flush arrangement of the shaped part 5 in the glass laminate 1.

FIG. 2 shows, by way of example, various shaped parts 5.1, 5.2, 5.3, 5.4, 5.5, 5.6 with different shapes of the second region 6.1, 6.2, 6.3, 6.4, 6.5, 6.6. In order that the second region 6.1, 6.2, 6.3, 6.4, 6.5, 6.6 of a shaped part 5.1, 5.2, 5.3, 5.4, 5.5, 5.6 can engage with the first polymer film 4 in a form-fitting manner in the sense of an undercut, said second region 6.1, 6.2, 6.3, 6.4, 6.5, 6.6 has to have a widened section and/or at least one incision or alternatively an opening 11.1, 11.2 which lies parallel to the plane of the glass plates 2, 3. The third shaped part 5.3 exhibits, by way of example, a second region 6.3 with an incision, whereas the shaped parts 5.1, 5.5, 5.6 have first regions 6.1, 6.5, 6.6 with widened sections.

The second shaped part 5.2 and also the fourth shaped part 5.4 in FIG. 2 exhibit, by way of example, variants of the first region 6.2, 6.4 with an opening 11.1, 11.2. A correspondingly dimensioned piece of the first film 4 is arranged within the opening 11.1, 11.2, in order to achieve the necessary undercut action.

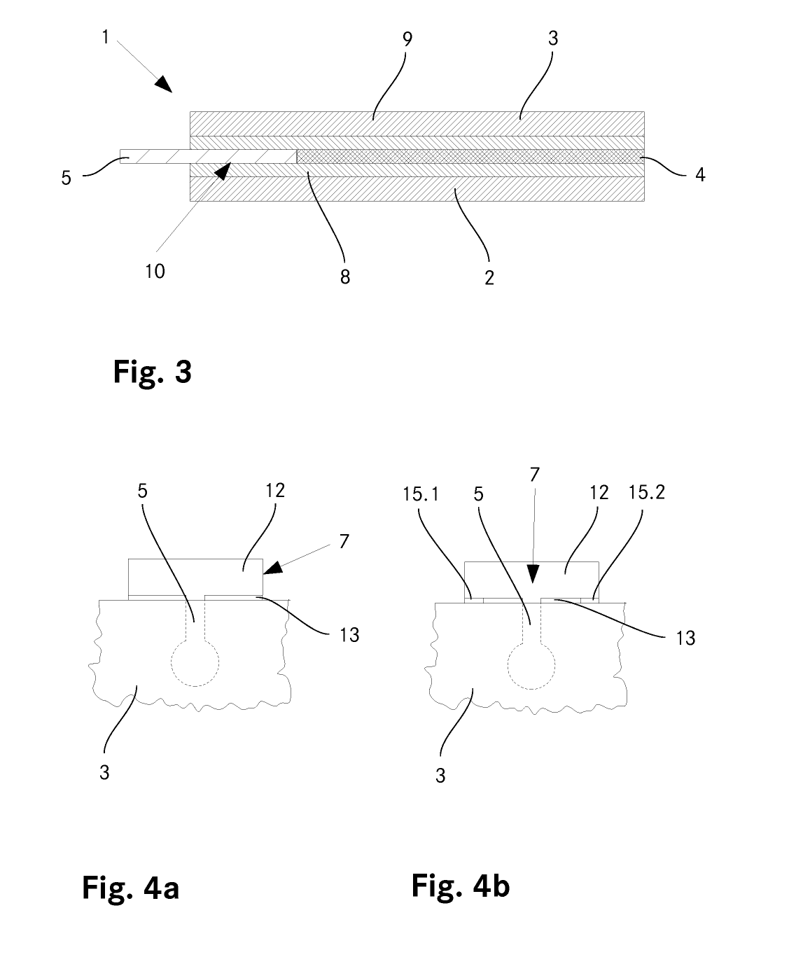

FIG. 3 shows a section through the glass laminate 1 shown in FIG. 1. A first layer of the second film 8 has been applied to the first glass plate 2 and covers substantially the entire surface of the first glass plate 2. The first polymer film 4, which has a cutout for the shaped part 5, has been applied to said first layer of the second polymer film 8. Accordingly, the shaped part 5 has been inserted into said cutout 10. It can readily be seen that the thickness of the shaped part 5 is substantially identical to the thickness of the first polymer film 4. A second layer of the second polymer film 9 has been applied over the first polymer film 4 and the shaped part 5. The second glass plate 9 lies on said second layer of the second film 9.

FIG. 4a shows an excerpt of a glass laminate 1 having a shaped part 5 with a connection element 12 arranged in the second region 7 of the shaped part 5. In this case, the connection element 12 is formed in one piece with the shaped part 5. Alternatively, it would also be possible for the connection element 12 to be connected to the second region 7 of the shaped part 5 in an integral manner, e.g. via a weld seam. A layer 13 of the first polymer film 4 is arranged between the connection element 12 and an edge of the glass laminate, that is an edge of the two glass plates 2, 3.

FIG. 4b shows an excerpt of a glass laminate 1 with an alternative variant of a connection element 12. In contrast to the embodiment shown in FIG. 4a, the at least one layer 13 of the first polymer film 4 has two recesses 14.1, 14.2, in each of which there is arranged an element 15.1, 15.2 made of a thermoplastic polymer, in particular of polymethyl methacrylate. The arrangement of the elements 15.1, 15.2 makes it possible to prevent the connection element 12 and therefore the entire shaped part 5 from being displaced on account of the fact that the polymer of the first polymer film 4 and also of the at least one layer 13 has softened owing to the lamination process, in particular makes it possible to prevent said connection element from tilting with respect to the edge of the glass laminate 1.

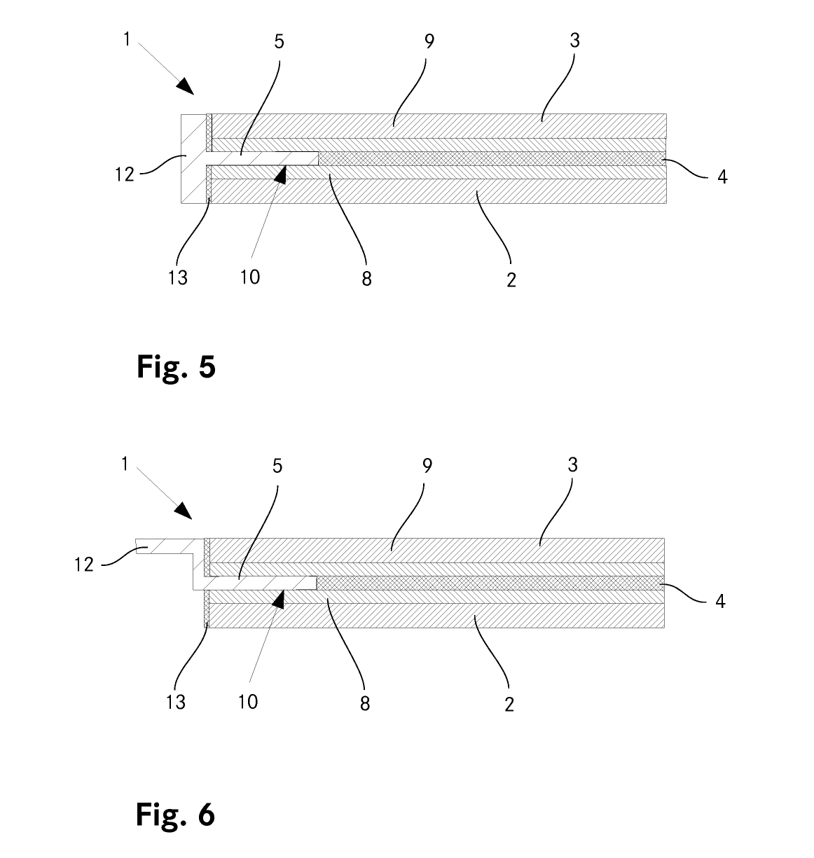

FIG. 5 shows a section through a glass laminate 1 as shown in FIG. 4a. It can clearly be seen that the connection element 12 has substantially the same thickness as the glass laminate 1. The layer 13 of the first polymer film 4, which is arranged between the connection element 12 and the edge of the glass laminate 1, can furthermore also be clearly seen. In this embodiment, the connection element 12 has a cuboidal form, a bottom side and top side of the connection element 12 standing flush with respect to a surface of the first glass plate 2 and respectively of the second glass plate 3.

FIG. 6 shows a glass laminate 1 as shown in FIG. 4a with an alternative embodiment of a connection element 12. The connection element 12 has a twofold rectangular bend, such that a surface of the connection element 12 stands flush with the surface of the second glass plate 3.

In principle, any desired shape is conceivable for the connection element 12, this providing a high degree of flexibility in terms of possible sites and purposes for use. Analogously to the embodiment shown in FIG. 4b, the at least one layer 13 in the two embodiments shown in FIG. 5 and FIG. 6 can of course also be provided with at least one recess 14 and an element 15 arranged therein.

1. A glass laminate comprising at least two glass plates, at least one first polymer film and also at least one shaped part made of metal being arranged between said at least two glass plates, and the at least one shaped part having substantially the same thickness as the at least one first polymer film and being arranged in a cutout in said at least one first polymer film, wherein the at least one shaped part has at least one first region which engages with the at least one first polymer film in a form-fitting manner in the form of an undercut, the at least one shaped part being arranged in the region of an edge of the glass laminate and having a width which is less than 10% of the total length of the edge.

2. The glass laminate as claimed in claim 1, wherein the at least one shaped part has a second region, which protrudes beyond the edge of the glass laminate.

3. The glass laminate as claimed in claim 2, wherein the shaped part has at least one connection structure in the at least one second region, at least one layer of the at least one first polymer film being arranged between the connection structure and the edge of the glass laminate.

4. The glass laminate as claimed in claim 3, wherein the at least one layer has at least one recess, in which there is arranged an element made of a thermoplastic polymer, in particular made of polymethyl methacrylate, having the same thickness as the at least one layer.

5. The glass laminate as claimed in claim 1, wherein the first polymer film comprises a polymer which has a modulus of elasticity of at least 100 N/mm² at a temperature of 50° C. and with a loading duration of less than 3 seconds.

6. The glass laminate as claimed in claim 1, wherein the at least one first polymer film comprises a polymer with a modulus of elasticity of at least 15 N/mm² at 50° C. and with a loading time of 1 hour.

7. The glass laminate as claimed in claim 1, wherein at least one second polymer film is arranged between the at least one first polymer film and at least one of the at least two glass plates, said second polymer films lying in the region of the cutout between the at least one shaped part and the at least two glass plates.

8. A process for producing a glass laminate according to claim 1, comprising at least two glass plates, a first polymer film and also at least one shaped part made of metal being arranged between said at least two glass plates, said process comprising the following steps:
a) providing a first glass plate;
b) providing the at least one shaped part made of metal and the first polymer film, the at least one shaped part comprising at least one first region which has an undercut;
c) producing a cutout in the first polymer film, the cutout corresponding to the shape and size of the at least one shaped part;
d) applying the first polymer film to the first glass plate;
e) inserting the at least one shaped part into the cutout;
f) applying a second glass plate;
g) combining the two glass plates at least by heating the first polymer film.

9. The process as claimed in claim 8, wherein at least one layer of a second polymer film is applied to the first glass plate and then the first polymer film is applied to said at least one layer of the second polymer film.

10. The process as claimed in claim 8, wherein at least one layer of a second polymer film is applied to the first polymer film and the shaped part before the second glass plate is applied.
